(19) United States
(12) Patent Application Publication
(10) Pub. No.: US 2020/0137258 A1
(43) Pub. Date: Apr. 30, 2020

(54) IMAGE FORMATION APPARATUS

(71) Applicant: Oki Data Corporation, Tokyo (JP)

(72) Inventor: Yuzuru IIOKA, Tokyo (JP)

(73) Assignee: Oki Data Corporation, Tokyo (JP)

(21) Appl. No.: 16/658,121

(22) Filed: Oct. 20, 2019

(30) Foreign Application Priority Data
Oct. 29, 2018 (JP) 2018-203168

(51) Int. Cl. H04N 1/053; H04N 1/00; H04N 1/034

(52) U.S. Cl. CPC H04N 1/053; H04N 1/00029; H04N 2201/0471; H04N 2201/04744; H04N 1/034

(57) ABSTRACT

An image formation apparatus according to an embodiment may include: a sensor unit provided at a movable part being movable in a main scanning direction; a driver configured to move a medium in a sub-scanning direction; a controller that controls the sensor unit, the movable part, and the driver, wherein the controller controls the sensor unit to detect the medium while controlling the movable part to move in the main scanning direction without driving the driver, and controls the sensor unit to detect the medium while controlling the movable part to move in the main scanning direction with controlling the driver to move the medium in the sub-scanning direction.

### CROSS REFERENCE TO RELATED APPLICATIONS

This application claims priority based on 35 USC 119 from prior Japanese Patent Application No. 2018-203168 filed on Oct. 29, 2018, the entire contents of which are incorporated herein by reference.

### BACKGROUND

The disclosure relates to an image formation apparatus.

An image formation apparatus, such as a copier, a facsimile, a multi-function printer, a peripheral (“MFP”), or the like, for example, an inkjet printer includes: a carriage configured to move along a rail; and recording heads mounted on the carriage and configured to eject inks of respective colors to attach the inks on a recording medium being conveyed, so as to form (print) a color image such as letters, pictures, and the like on the recording medium.

In a related art, a printer is known which identifies a type of a recording medium based on an output of a medium detector such as an optical sensor or the like, and executes printing under a setting suitable for properties of the identified type of the recording medium.

The printer stops the medium and the medium detector, emits light from a light emitter of the medium detector to the recording medium, and receives by a light receiver or a light detector light reflected from the recording medium. The controller of the printer identifies a type of the recording medium based on the sensor output of the light receiver, that is, the sensor output of the medium detector, and sets a print setting suitable for the identified type of the medium (see for example, Patent Document 1).

Patent Document 1: Japanese Patent Application Laid-Open No. 2016-215590

### SUMMARY

However, the printer of the related art may be unable to appropriately identify a type of a medium and thus may be unable to set an appropriate print setting suitable for the medium. Especially in a case where a retroreflective medium, for example, to be used for a traffic sign or the like, is used as the recording medium, it may be difficult to identify a type of the recording medium, because the retroreflective medium has a structural characteristics that do not uniformly reflect the light.

For example, in a case where a normal recording medium such as a paper sheet, a resin film, or the like is used, the light emitted from the light emitter to the recording medium is reflected by specular reflection or diffuse reflection, and the reflected light of the specular reflection or the diffuse reflection is received by the light receiver.

To the contrary, the retroreflective medium has a structure which, for example, includes a base layer and an intermediate layer on the base layer, wherein the intermediate layer includes a support layer and a reflective layer wherein the reflective layer includes a prismatic layer and an air layer. Thus, in a case where the retroreflective medium is used as the recording medium, the light emitted from the light emitter of the medium detector to the recording medium is reflected on the reflective layer of the retroreflective medium by a retroreflective reflection, and thus the reflected light returns to the light emitter. Therefore, the light receiver does not receive or scarcely receives the reflected light, and thus the controller cannot obtain the sensor output of the medium detector at an appropriate amount and cannot appropriately identify the type of the recording medium.

Therefore, in the case where the recording medium is a retroreflective medium, the printer cannot execute printing under settings suitable for the characteristics of the recording medium.

Furthermore, depending on types of retroreflective media and manufacturers of the retroreflective media, structures of the retroreflective media are different. Thus, the printer cannot execute printing under settings suitable for the characteristics of each of the retroreflective media.

An object of an embodiment may be to provide an image formation apparatus that can appropriately identify a type of a recording medium based on an output of a sensor unit and execute printing under settings suitable for the characteristics of the recording medium.

An aspect of one or more embodiments may be an image formation apparatus that may include: a sensor unit provided at a movable part being movable in a main scanning direction; a driver configured to move a medium in a sub-scanning direction; a controller that controls the sensor unit, the movable part, and the driver, wherein the controller controls the sensor unit to detect the medium while controlling the movable part to move in the main scanning direction without driving the driver, and controls the sensor unit to detect the medium while controlling the movable part to move in the main scanning direction with controlling the driver to move the medium in the sub-scanning direction.

According to the aspect, the image formation apparatus may appropriately identify a type of the recording medium based on an output of sensor unit since the image formation apparatus can scan by the sensor unit the medium along the main scanning direction and along a direction inclined with respect to the main scanning direction.

### BRIEF DESCRIPTION OF DRAWINGS

FIG. 1 is a control block diagram illustrating a view of an inkjet printer as an image formation apparatus according to one or more embodiments.

FIG. 2 is a diagram illustrating a perspective view of the inkjet printer according to one or more embodiments.

FIG. 3 is a diagram illustrating a conceptual view of a part of the inkjet printer according to one or more embodiments.

FIG. 4 is a diagram illustrating a conceptual view of a part of the inkjet printer according to one or more embodiments.

FIG. 5 is a diagram illustrating a conceptual view of a retroreflective medium according to one or more embodiments.

FIG. 6 is a diagram illustrating a view (1) for explaining an operation of a medium identifying part according to one or more embodiments.

FIG. 7 is a diagram illustrating a view (2) for explaining the operation of the medium identifying part.

FIG. 8 is a graph illustrating peak waveforms generated from a detection result of a sample retroreflective medium.

FIG. 9 is a diagram illustrating a flow chart of an operation of the inkjet printer according to one or more embodiments.

FIG. 10 is a diagram illustrating a flow chart of a subroutine of a first print process according to one or more embodiments.

FIG. 11 a diagram illustrating a flow chart of a subroutine of a second print process according to one or more embodiments.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

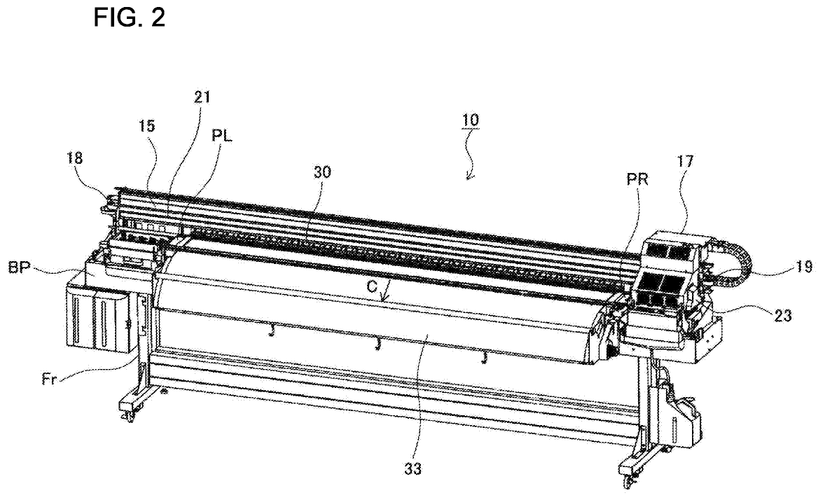

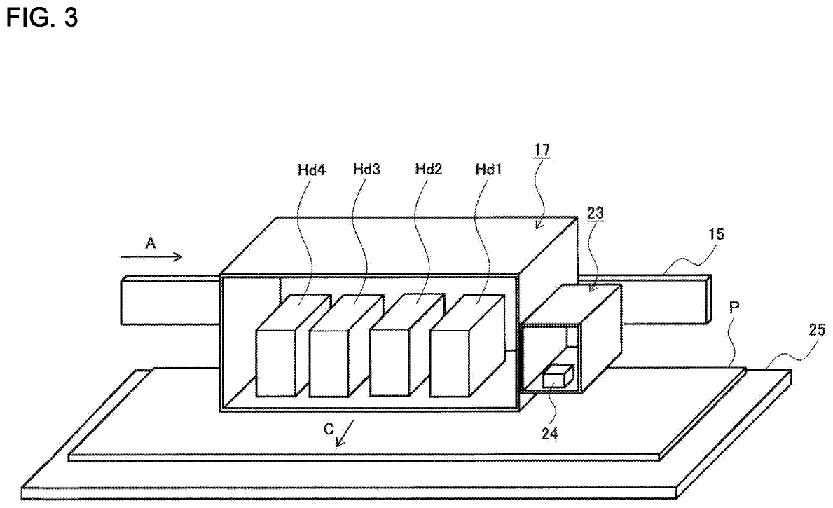

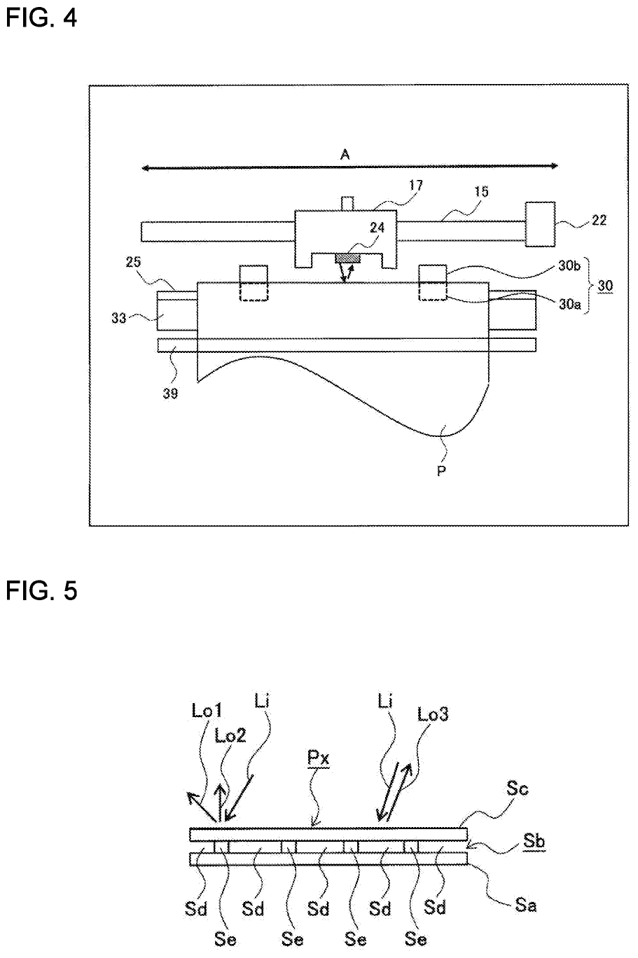

In the following descriptions, an inkjet printer is explained as an example of an image formation apparatus. FIG. 2 is a diagram illustrating a perspective view of the inkjet printer according to one or more embodiments. FIG. 3 is a diagram illustrating a conceptual view of a part of the inkjet printer according to one or more embodiments. FIG. 4 is a diagram illustrating a conceptual view of a part of the inkjet printer according to one or more embodiments. FIG. 5 is a diagram illustrating a conceptual view of a retroreflective medium according to one or more embodiments.

In the drawings, 10 designates the inkjet printer, Fr designates a main body of the inkjet printer 10, that is a frame of the apparatus body. The frame Fr includes a base plate BP, a frame member PL serving as a first support member, and a frame member PR serving as a second support member. As seen from a front side of the inkjet printer 10 (that is, in a view of FIG. 2), the base plate BP extends from a left end to a right end of the main body, the frame member PL is projected upwardly from the base plate at a position away from the left end of the based plate BP by a predetermined distance, and the frame member PR is projected from the based plate BP at a position away from the right end of the based plated by a predetermined distance.

A rail 15 linearly extends and is provided (bridges) between the left and right ends of the base plate BP. A carriage 17 serving as a movable part is provided to be movable along the rail 15 in the left-right direction, that is, in a main scanning direction (the direction of the arrow A). On the carriage 17, plural (e.g., four in an embodiment) recording heads Hdi (i=1, 2, . . . , 4) or inkjet heads serving as image formation parts are mounted. Each of the recording heads Hdi includes a nozzle surface (a surface of the recording head that includes openings of nozzles) facing in a downward direction. In an embodiment, ink drops of black, yellow, magenta and cyan are ejected from the nozzles of respective recording heads Hdi, so as to form a color image (multi-color image) on the recording medium.

A driving side pulley 18 is rotatably provided in the vicinity of a left end of the rail 15, and a driven side pully 19 is rotatably provided in the vicinity of a right end of the rail 15. An endless belt 21 is provided between and stretched by the pulleys 18 and 19 in such a way as to be capable of being conveyed by the pulleys 18 and 19. The carriage is attached to a predetermined position of the endless belt 21. A carriage motor 22, serving as a drive unit or a driver for moving the carriage, is connected to the pully 19.

Accordingly, by activating the carriage motor 22 to move the endless belt 21, the carriage 17 having the recording heads Hdi thereon is moved along the main scanning direction. At the same time, the color inks are ejected from the nozzles of the respective recording heads Hdi, while the recording medium P is conveyed in a direction vertical to the moving direction of the carriage 17, that is, a sub-scanning direction or a vertical scanning direction (the direction of the arrow C). With this, the color inks ejected from the respective recording heads Hdi are attached to the recording medium P, so as to from (print) a color image of letters, pictures, and/or the like on the recording medium P. Note that a paper sheet, a film of resin such as chloroethylene, PET, or the like, a retroreflective medium Px, or the like may be used as the recording medium P.

A sensor unit 23 is mounted on a right side (a side of the home position) of the carriage 17. In the sensor unit 23, an optical sensor 24 is provided. Accordingly, the optical sensor 24 is movable in the main scanning direction, along with movements of the carriage 17 in the main scanning direction.

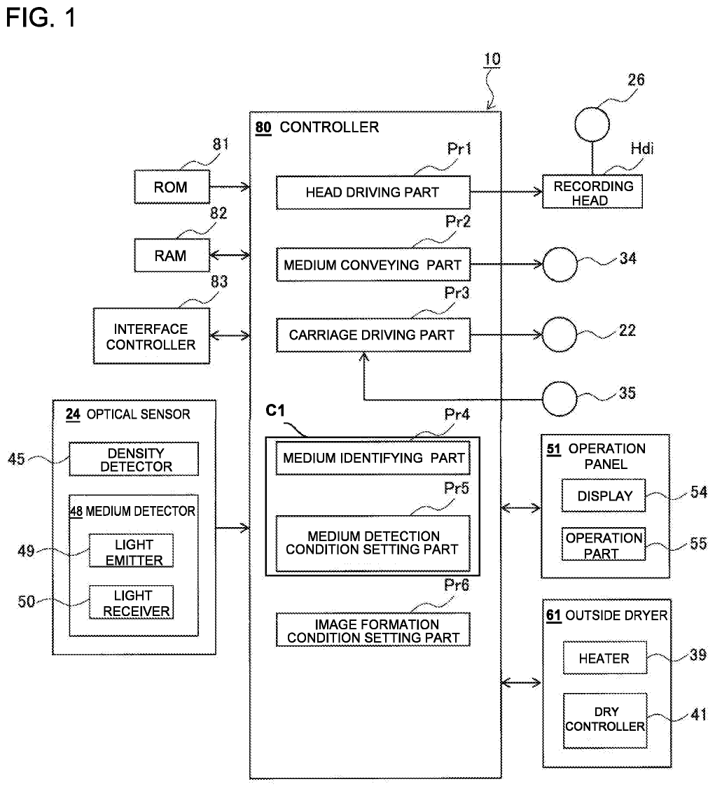

A linear scale (not illustrated) is provided linearly extending along and parallel to the rail 15 in such a manner that a scale of the linear scale can be optically read by a encoder 35 (see FIG. 1) mounted on the carriage 17, to detect a position of the carriage 17 based on a sensor output of the encoder 35. Thus, based on a change of the position of the carriage 17 in relation with the time, a movement speed of the carriage 17 can be calculated.

A platen 25, made of metal and having a plate shape, is provided linearly extending along and parallel to the rail 15. The platen 25 is provide on the base plate between the frame members PL and PR, in such a manner that the platen 25 supports thereon the recording medium P being conveyed on the platen 25.

On a rear side of the platen 25, an upstream guide (not illustrated) serving as a first medium guide is provided. The upstream guide is provided on an upstream side of the platen 25 in a medium conveyance direction and is configured to guide to the platen 25 the recording medium P drawn from a feed roll (not illustrated). Between the upstream guide and the platen 25 in the medium conveyance direction, conveying roller pairs 30 serving as conveyance members are rotatably provided.

The conveying roller pair 30 includes conveying rollers 30a serving as first rollers extending in the main scanning direction of the inkjet printer 10 and rotatably provided in the vicinity of the platen 25 and pinch rollers 30b serving as second rollers rotatably provided above the conveying rollers 30a at plural positions and pressed against the conveying roller 30a. When a conveyance motor 34 serving as a drive unit or a driver for conveying the medium is activated to rotate the conveying rollers 30a, the pinch rollers 30b are driven to rotate by the rotations of the conveying rollers 30a.

With this, the recording medium P is conveyed, with being pinched between the conveying rollers 30a and pinch rollers 30b along the upstream guide, to be fed onto the platen 25. Then, when the recording medium P is conveyed to a position opposed to the nozzle surfaces of the recording heads Hdi, the inks of the respective colors are ejected from the nozzles and attached onto the recording medium P, to form (print) an image on the recording medium P.

On a front side of the platen 25, a downstream guide 33 serving as a second guide is provided to guide the printed recording medium P to be discharged. The downstream guide is formed in a bent shape to downwardly guide the recording medium P discharged horizontally from the platen 25.

Accordingly, the recording medium P is drawn from the feed roll, guided by the upstream guide to the platen 25, printed on the platen 25 with the inks ejected from the nozzles of the recording heads Hdi to the recording medium P, guided by the downstream guide 33, and then taken up by a winding device (not illustrated). Note that a medium conveyance path is defined along the upstream guide, the platen 25, and the downstream guide 33.

Incidentally, the printed recording medium P has the inks attached thereto. Thus, if the printed recording medium P is discharged from the inkjet printer 10 and taken up by the winding device before the inks is dried, the recording medium P would get dirty by the undried ink.

In an embodiment, in order to dry the inks attached on the recording medium P to fix the ink to the recording medium P, the inkjet printer 10 includes a heater (not illustrated) serving as a first heater provided to the platen 25, a heater (not illustrated) serving as a second heater provided upstream of the platen 25 and on a back side of (below) the upstream guide, and a heater (not illustrated) serving as a third heater provided downstream of the platen 25 and on a backside of (below) the downstream guide 33. Each of the heaters is covered with and surrounded by an aluminum sheet. Accordingly, the recording medium P, which is conveyed through the upstream guide, the platen 25, and the downstream guide 33, is heated by the heaters, and thus the inks attached to the recording medium P can be sufficiently dried.

By the way, it is preferable that traffic signs on roads or the like have a good noticeability to be recognized by a driver or the like, when a headlight of a vehicle as a light source is turned on to emit light. Accordingly, a retroreflective medium Px such as illustrated in FIG. 5 may be used as a recording medium, on which an image is printed, to be used for an irradiated member such as a traffic sign or the like.

Such a retroreflective medium Px includes, for example, a base layer Sa, an intermediate layer Sb on the base layer Sa, and a film layer Sc (or a surface layer) on the intermediate layer Sb, such that an image of a traffic sign is able to be printed on the film layer Sc.

The intermediate layer Sb includes: a reflective layer Sd including a prismatic layer containing a plurality of prisms and an air layer surrounding the prisms; and a support layer Se (bonding agent layer) as a frame part for the reflective layer Sd having a predetermined shape to dividing the reflective layer into plural sections and maintain a thickness of the reflective layer Sd.

The light Li that is incident on the prisms in the prismatic layer in the reflective layer Sd, is refracted in the prisms to return in the direction opposite to the incident direction.

When the light Li from the headlight of the vehicle is irradiated to the retroreflective medium Px, the light Li passes through the film layer Sc to the intermediate layer Sb and is reflected on the intermediate layer Sb, so that the reflected lights Lo1 to Lo3 are emitted through the film layer Sc.

At this time, a specular reflection or a diffuse reflection occurs on the support layer Se of the intermediate layer Sb, in a way same as or similar to the a normal recording medium such as a paper sheet, a resin film, or the like, while the retroreflective reflection occurs on the reflective layer Sd of the retroreflective medium due to the refraction in the prisms. Thus, the reflected lights Lo1 and Lo2 by the specular reflection or the diffuse reflection on the support layer Se are radiated through the film layer Sc in directions, while the reflected light Lo3 by the retroreflective reflection on the reflective layer Sd is returned through the film layer Sc to the vehicle in a direction.

Thus, the reflected light Lo3 returned to the vehicle can be noticeably recognized by the driver of the vehicle, due to the retroreflective medium Px of the traffic sign.

However, an image formation condition (setting) for forming an image on a retroreflective medium Px is different an image formation condition (setting) for a normal recording medium. For example, the image formation condition for the retroreflective medium Px that is different from that for the normal recording medium may include: a driving condition of the recording heads Hdi; a conveyance condition of the recording medium P; the number of paths when recording one line, a density of the image to be formed on the recording medium P; a drying condition of ink applied on the recording medium P; or the like.

Accordingly, in an embodiment, before starting a printing process, the printer 10 detects the recording medium P by the optical sensor 24 while moving at least the carriage 17 out of the carriage 17 and the recording medium P, identifies whether the recording medium P is a retroreflective medium Px or not, and changes the image formation condition when the recording medium P is determined to be the retroreflective medium Px.

Note that the printer 10 includes a heater 39 (e.g., an infrared heater in an embodiment) serving as a fourth heater is provided downstream from the platen 25 in the conveyance direction of the recording medium P (e.g., downstream from the downstream guide 3 in an embodiment) such that the heater 39 faces the recording medium P and extends over the entire width of the recording medium P. When the recording medium P is determined to be a retroreflective medium Px, the printer 10 change the image formation condition to turn on the heater 39 so that the ink applied on the recording medium P is directly dried from a side (e.g. a front surface side) of the medium on which the ink is applied, by radiation heat of the heater 39.

Next, a control device of the inkjet printer 10 is explained.

FIG. 1 illustrates a view of a control block diagram of the inkjet printer according to one or more embodiments.

In the figure, 10 designates the inkjet printer, 24 designates the optical sensor, 51 designates an operation panel, 61 designates an outside dryer, 80 designates a controller that controls the sequence in the entire of the inkjet printer 10 to control printing or the like, 81 designates a non-volatile memory such as a ROM serving as a first storage unit, 82 designates a volatile memory such as a RAM serving as a second storage unit, 83 designates an interface controller that receives print data from an external apparatus or an information process apparatus such as a host computer (not illustrated) and stores the print data to the RAM 82. In an embodiment, the printer 10 receives the print data through a USB cable or the like, however, may receive through a wireless LAN or the like.

The optical sensor 24 includes a density detector 45. The density detector 45 includes a light emitter (not illustrated) such as a LED or the like, and a light receiver or light detector (not illustrated) such as a phototransistor or the like. The density detector 45 emits a light generated by the light emitter to the recording medium P, and receives, by the light receiver, the light reflected by the recording medium P, to detect a density (a contrast) of the image of each color.

The optical sensor 24 also includes a medium detector 48. The medium detector 48 includes a light emitter 49 such as a LED or the like, and a light receiver 50 or a light detector such as a phototransistor or the like. The medium detector 48 emits a light generated by the light emitter 49 to the recording medium P, and receives, by the light receiver 50, the light reflected by the recording medium P, to detect the recording medium P.

Thus the medium detector 48 is moved by movements of the carriage 17 (see FIG. 2) in the main scanning direction to scan the recording medium P on the platen.

The medium detector 48 detects plural points on the recording medium P along the main scanning direction to generate the sensor output by the light receiver 50. For example, the medium detector 48 detects the recording medium P at predetermined regular intervals of about 0.001 mm to 1 mm inclusive along the main scanning direction to generate the sensor output by the light receiver 50.

Note that while the medium detector 48 scans the recording medium along the main scanning direction, the recording medium P may be conveyed on the platen 25 at a predetermined conveyance speed or be stopped on the platen 25.

The operation panel 51 includes a display 54 such as a LED display or the like to display a status of the inkjet printer 10 and an operation part 55 or an input part including a switch(es), a key(s), and/or the like through which an operator or a user inputs an instruction to the inkjet printer 10. Note that in a case where the operation panel 51 is composed of a touch panel, the display 54 may function as an operation part as well.

The outside dryer 61 includes the heater 39 provided outside of the guides to face the recording medium P, and a dry controller 41 configured to control the entire of the outside dryer 61 and turn on and off the heater 39 by controlling a power distribution to the heater 39.

The controller 80 includes a CPU serving as an arithmetic device or a processor, an input/output port(s), a timer, and the like and executes various operations based on programs stored in the ROM 81. For example, the controller 80 executes various operations comprising an operation as a head driving part Pr1 or a head drive processor, an operation as a medium conveying part Pr2 or a medium conveyance processor, an operation as a carriage driving part Pr3 or a carriage drive processor Pr3, an operation as a medium identifying part Pr4 or a medium identification processor Pr4, an operation as a the medium detection condition changing part Pr5 or a medium detection condition changing processor Pr5, an operation as an image formation condition setting part Pr6 or image formation condition setting processor Pr6, and the like. Note that the medium identifying part Pr4 and the medium detection condition changing part Pr5 forms a medium processing part C1 or a medium processor.

The ROM 81 also stores therein various setting values used for the various operations. For example, the ROM 81 stores therein setting values used by the medium identifying part Pr4 for identifying types of the recording medium P.

The RAM 82 temporarily stores therein an image data to execute printing generated based on the print data, and various data for controlling. Note that the RAM 82 functions as a work area in which the CPU executes computing.

In the controller 80, the head driving part Pr1 reads out the print data from the RAM 82, converts the print data to generate an image data, transmits the generated image data to the recording heads Hdi, and drives the recording heads Hdi to form an image based on the generated image data on the recording medium P.

Note that each of the recording heads Hdi includes a piezo element 26 serving as a driving element for each nozzle. When a voltage is applied between electrodes (not illustrated) provided at both ends of the piezo element 26, the piezo element 26 is driven to expand or contract in response to the applied voltage to deform a side wall of an ink path in which the ink is flowed to the nozzle in the recording head Hdi, so as to change the cross-part area of the ink path, to eject a drop of the ink by an amount of the change of the cross-section area of the ink path.

The medium conveying part Pr2 performs a conveyance process, by transmitting a drive signal to the conveyance motor 34 to drive the conveyance motor 34, so as to rotate the conveying roller pairs 30 (see FIG. 2), which conveys the recording medium P in the direction of the arrow C (the sub-scanning direction).

The carriage driving part Pr3 performs carriage drive processing by performing a PWM control to drive the carriage motor 22, so as to rotate (move) the endless belt 21, which can reciprocate the carriage 17 in the direction of the arrow A (the main scanning direction). Accordingly, the carriage driving part Pr3 reads out from the ROM 81 a target position and a target speed of the carriage 17, receives the output of the encoder 35, performs an analog-digital conversion of the output to detect the position of the carriage 17, generates a PWM control signal as a control value, and transmits the PWM control signal to the carriage motor 22. The carriage motor 22 receives the PWM control signal, changes the rotational speed thereof in proportion to a duty ratio of the PWM control signal, so as to move the carriage 17 to the target position at the target speed while accelerating and decelerating the moving speed thereof. Then, the carriage driving part Pr3 transmits the position of the carriage 17 to the head driving part Pr1, and the head driving part Pr1 ejects the ink drops from the nozzles of each recording head Hdi at the timing calculated based on the position of the carriage 17 and the image data. Note that the medium processing part C1 includes the medium identifying part Pr4 and the medium detection condition changing part Pr5.

The medium identifying part Pr4 executes a medium identifying process before executing printing on the recording medium P. That is, before executing printing on the recording medium P, the medium identifying part Pr4 moves the carriage 17 along the main scanning direction while the recording medium P is being conveyed on the platen 25 or is stopped, to thereby detect the recording medium P by the medium detector 48 under a predetermined condition, and identifies a type of the recording medium P, that is, determines whether the recording medium P is a retroreflective medium Px or not (a normal recording medium).

The medium detection condition changing part Pr5 executes a medium detection condition changing process, when the type of the recording medium P cannot be identified. That is, when the type of the recording medium P cannot be identified, the medium detection condition changing part Pr5 changes the condition for detecting the recording medium P, such as a moving speed of the carriage 17, a moving range of the carriage 17, a position of the recording medium P, a conveyance speed of the recording medium P, or the like.

The image formation condition setting part Pr6 executes an image formation condition setting process. That is, the image formation condition setting part Pr6 sets different image formation conditions between when the recording medium P is a normal recording medium and when the recording medium P is a retroreflective medium Px. For example, the image formation condition setting part Pr6 sets, when the recording medium P is the normal recording medium, an image formation setting in which the recording medium is not to be heated by the heater 39 and changes, when the recording medium P is the retroreflective medium Px, the image formation setting to another image formation setting in which the recording medium P is to be heated by the heater 39.

Next, an operation of the medium identifying part Pr4 is explained.

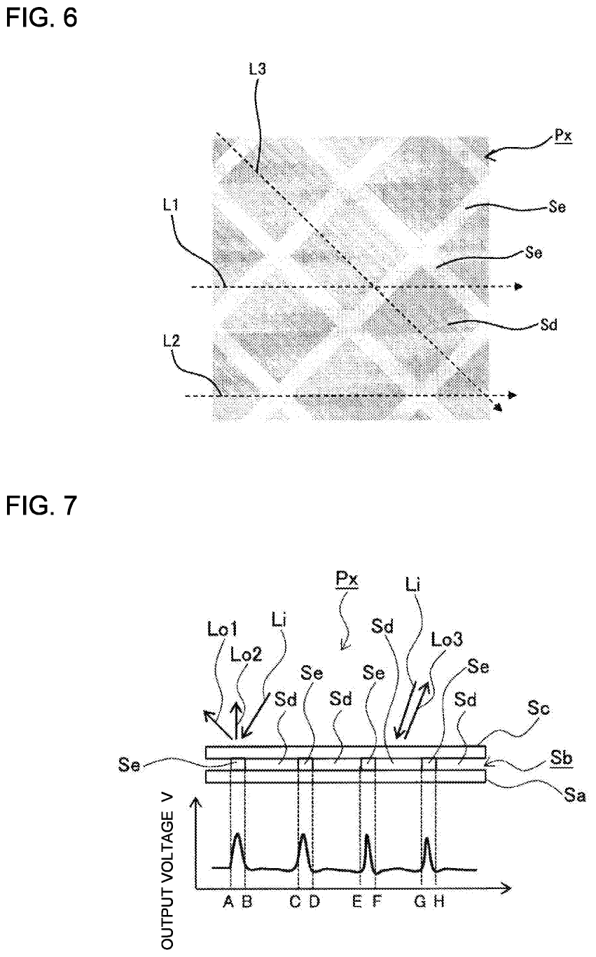

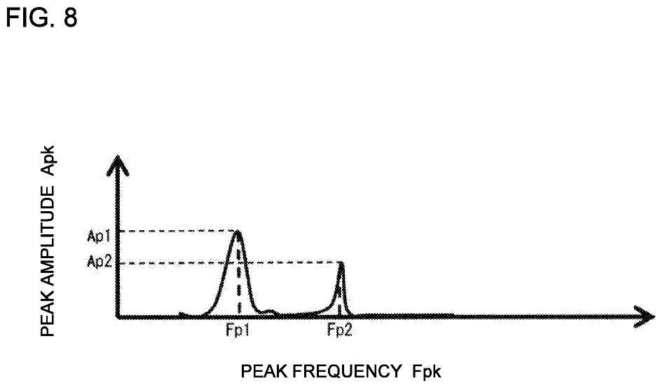

FIG. 6 is a diagram illustrating a view (1) for explaining the operation of the medium identifying part according to one or more embodiments. FIG. 7 is a diagram illustrating a view (2) for explaining the operation of the medium identifying part. FIG. 8 is a graph illustrating peak waveforms generated from a detection result of a sample retroreflective medium. Note that in FIG. 7, the horizontal axis represents a position on the retroreflective medium Px at which the light emitter 49 (see FIG. 1) emits the light, and the vertical axis represents an output voltage V of the sensor output of the light receiver 50. In FIG. 8, the horizontal axis represents the peak frequency of the peak waveforms generated from the sensor output which is the detection result of the sample retroreflective medium, and the vertical axis represents the peak amplitude of the peak waveforms.

As illustrated in the drawings, the retroreflective medium Px includes the base layer Sa, the intermediate layer Sb on the base layer Sa, and the film layer Sc (surface layer) on the intermediate layer Sb, such that an image is to be printed on the film layer Sc.

For example, the intermediate layer Sb includes: the reflective layer Sd including the prismatic layer containing the plurality of prisms and the air layer surrounding the prisms; and the support layer Se (bonding agent layer) functioning as the frame part for the reflective layer Sd having the predetermined shape to maintain the thickness of the reflective layer Sd.

When the light emitter 49 of the medium detector 48 emits light while the carriage 17 is being moved along the main scanning direction in the state where the retroreflective medium Px is stopped, the light Li is irradiated to the retroreflective medium Px along a line L1 or L2. When the light emitter 49 of the medium detector 48 emits light while the carriage 17 is being moved along the main scanning direction and the retroreflective medium Px is being conveyed, the light Li is irradiated to the retroreflective medium Px along a line L3. The light Li irradiated to the retroreflective medium Px is incident on the prisms in the prismatic layer in the reflective layer Sd, is refracted in the prisms, and is returned in the direction opposite to the incident direction.

Accordingly, when the light Li is irradiated from the light emitter 49 to the retroreflective medium Px, the light Li passes through the film layer Sc to the intermediate layer Sb, reflected by the intermediate layer Sb, so that the reflected lights Lo1 to Lo3 are returned through the film layer Sc.

At this time, a specular reflection or a diffuse reflection occurs on the support layer Se of the intermediate layer Sb, in a way same as or similar to a normal recording medium, while the retroreflective reflection occurs on the reflective layer Sd of the retroreflective medium due to the refraction in the prisms. Thus, the reflected light Lo1 by the specular reflection and the reflected light Lo2 by the diffuse reflection on the support layer Se are radiated through the film layer Sc in directions, while the reflected light Lo3 by the retroreflective reflection on the reflective layer Sd is returned through the film layer Sc to the light emitter 49.

The light emitter 49 and the light receiver 50 of the optical sensor 24 are arranged to be adjacent to each other in the main scanning direction. Thus, when the light emitter 49 and the light receiver 50 are located above the support layer Se and the light emitter 49 emits the light Li, the reflected light Lo1 goes to the light receiver 50. However, when the light emitter 49 and the light receiver 50 are located at a position other than above the support layer Se and the light emitter 49 emits the light Li, the reflected light Lo3 is returned to the light emitter 49 and does not go to the light receiver 50.

FIG. 6 illustrates a relationship between the output voltage V of the light receiver 50 of the optical sensor 24 and the position of the optical sensor 24 with respect to the retroreflective medium Px that has the support layer Se formed in the areas A-B, C-D, E-F, and G-H of the retroreflective medium Px. As illustrated in FIG. 6, while the optical sensor 24 is passing above the area A-B, the area C-D, the area E-F, and the area G-H of the retroreflective medium Px, the output voltage V of the light receiver 50 is high. While the optical sensor 24 is passing above the reflective layer Sd of the retroreflective medium Px, the output voltage V of the light receiver 50 is low. That is, when the medium P is the retroreflective medium Px, the sensor output varies at a frequency(s) corresponding to a design or a pattern of the support layer Se of the retroreflective medium Px.

Therefore, in an embodiment, the medium identifying part Pr4 obtains the sensor output of the light receiver 50, executes a frequency analysis on the obtained sensor output, creates one or more peak waveforms Wpk (k=1, 2, . . . ) indicating characteristics of the sensor output, and calculates, on each of the peak waveforms Wpk, a peak frequency Fpk (k=1, 2, . . . ) serving as a first medium characteristic index and a peak amplitude Fpk (k=1, 2, . . . ) serving as a second medium characteristic index, which represent characteristics of the recording medium P.

In order to compare the peak frequency Fpk and the peak amplitude Fpk of each peak waveform Wpk of the obtained sensor output with those of known (or sample) retroreflective media Px of the number N, which are different from each other based on manufactures of the retroreflective media Px and types of the retroreflective media Px, for identifying the type of the recording medium P by the medium identifying part Pr4, that is, for identifying whether the recording medium P is a normal recording medium or a retroreflective medium Px, ROM 81 has stored therein in advance, as reference values for medium type identification, peak frequencies fpj (j=1, 2, . . . , n) and peak amplitudes apj (j=1, 2, . . . , n) of each of the known retroreflective media Px, which have been calculated in advance based on detection results thereof.

Accordingly, the medium identifying part Pr4 reads out from ROM81 the peak frequencies fpj and the peak amplitudes apj of each of the known retroreflective media Px, compares the peak frequencies Fpk and the peak amplitudes Fpk of the sensor output with the peak frequencies fpj and the peak amplitudes apj of each of the known retroreflective media Px, and determines whether the peak frequencies Fpk and the peak amplitudes Fpk of the sensor output are matched with the peak frequencies fpj and the peak amplitudes apj of any one of the known retroreflective media Px. When the peak frequencies Fpk and the peak amplitudes Fpk of the sensor output are matched with the peak frequencies fpj and the stored peak amplitudes apj of one of the known retroreflective media Px, the medium identifying part Pr4 determines that the recording medium P is a retroreflective medium Px. When the peak frequencies Fpk and the peak amplitudes Fpk of the sensor output are not matched with the peak frequencies fpj and the peak amplitudes apj of any one of the known retroreflective media Px, the medium identifying part Pr4 cannot identify a type of the recording medium P and thus the medium detection condition changing part Pr5 changes a medium detection condition under which the medium detector 48 detects the recording medium P.

Next, an operation of the inkjet printer 10 is explained.

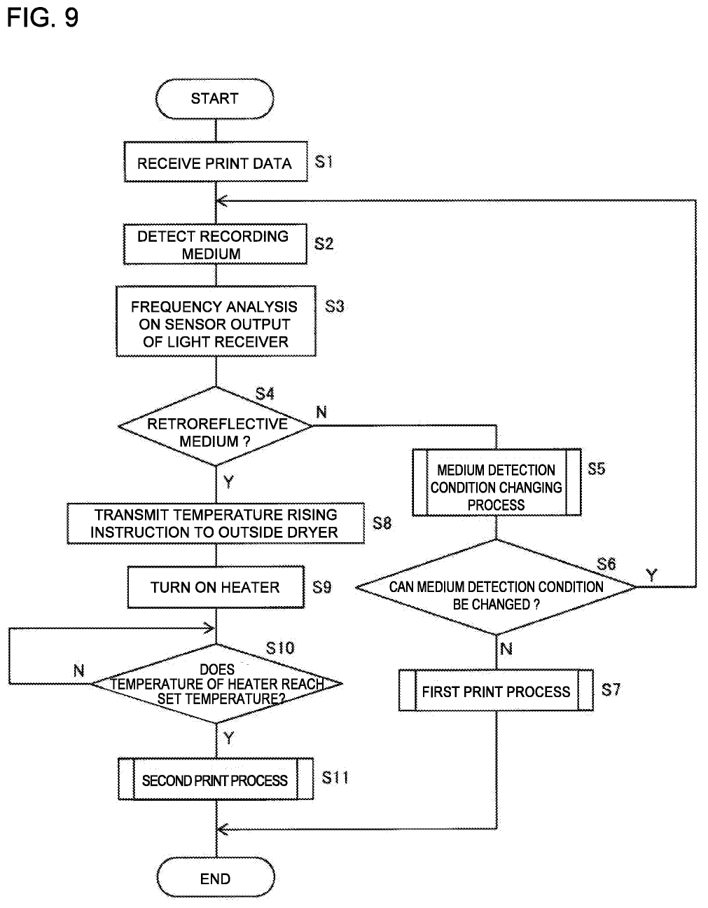

FIG. 7 is a diagram illustrating a flow chart of an operation of the inkjet printer according to one or more embodiments. FIG. 8 is a diagram illustrating a flow chart of a subroutine of a first print process according to one or more embodiments. FIG. 9 a diagram illustrating a flow chart of a subroutine of a second print process according to one or more embodiments.

First, the interface controller 83 receives the print data from the host computer and saves the print date in the RAM 82.

Next, the carriage driving part Pr3 drives the carriage motor 22 to move the carriage 17 at a predetermined movement speed in the main scanning direction within a predetermined movement range from a first predetermined position to a second predetermined position above the recording medium P.

The medium identifying part Pr4 controls the medium detector 48 to detect the recording medium P while moving the optical sensor at the predetermined movement speed within the predetermined movement range as a preset medium detection condition.

With this, the light emitter 49 of the medium detector 48 emits the light Li along the line L1 on the recording medium P, while the medium conveying part Pr2 keeps the recording medium stopped by not driving the conveyance motor 34.

Accordingly, the medium detector 48 emits the light Li from the light emitter 49 to the recording medium P and receives the reflected light Lo1 which is reflected on the recording medium P by the light receiver 50, so as to detect the recording medium P. When detecting the recoding medium P, the medium identifying part Pr4 stores into ROM 81 variation of the sensor output of the light receiver 50 associated with the detection positions which are positions on the recording medium P where the optical sensor 24 detects. The detection positions of the optical sensor 24 may be calculated based on an output of the encoder 35, the number of rotations of the carriage motor 22, a movement amount of the carriage 17 proportional to the number of the rotations of the carriage motor 22, the number of rotations of the conveyance motor 34, or a movement amount of the recording medium P proportional to the number of the rotations of the conveyance motor 34, for example.

When the medium detector 48 finishes the detection of the recording medium P, the medium identifying part Pr4 reads out from the ROM81 the sensor output and the detection positions, performs the frequency analysis on the sensor output, creates one or more peak waveforms Wpk indicating characteristics of the sensor output, and calculates, on each of the peak waveforms Wpk, the peak frequency Fpk and the peak amplitude Fpk.

Then, the medium identifying part Pr4 reads out from the ROM81 the peak frequencies fpj and the peak amplitudes apj of each of the known retroreflective media Px, compares the peak frequencies Fpk and the peak amplitudes Fpk of the sensor output with the peak frequencies fpj and the peak amplitudes apj of each of the known retroreflective media Px, and determines whether or not the recording medium P is a retroreflective medium Px based on whether the peak frequencies Fpk and the peak amplitudes Fpk of the sensor output are matched with the peak frequencies fpj and the peak amplitudes apj of one of the known retroreflective media Px. When the peak frequencies Fpk and the peak amplitudes Fpk of the sensor output are matched with the stored peak frequencies fpj and the stored peak amplitudes apj of one of the known retroreflective media Px, the medium identifying part Pr4 determines that the recording medium P is a retroreflective medium Px. When the peak frequencies Fpk and the peak amplitudes Fpk of the sensor output are not matched with the peak frequencies fpj and the peak amplitudes apj of any one of the known retroreflective media Px, the medium detection condition changing part Pr5 performs the medium detection condition changing process. In the medium detection condition changing process, the medium detection condition changing part Pr5 determines if it is possible to change from the current medium detection condition for detecting the recording medium P to one of predetermined medium detection conditions which are registered in advance, and changes, when it is determined that it is possible, the current medium detection condition by changing the movement speed of the carriage 17, the movement range of the carriage 17, the position of the recording medium P, the conveyance speed of the recording medium P, or the like.

As an example, the medium detection condition changing part Pr5 may change the movement range of the carriage 17 to be wider, so as to increase the number of peak waveforms Wpk to be generated.

As an example, the medium detection condition changing part Pr5 may control the medium conveying part Pr2 to convey the recording medium P by a predetermined distance on the platen 25 to thereby change the position of the recording medium P on the platen 25, so that the light emitter 49 of the medium detector 48 can emit the light Li to the recording medium P along the line L2. Thus, the medium identifying part Pr4 can analyze the sensor output along the line L2 on the recording medium P.

As an example, the medium detection condition changing part Pr5 may change to a medium detection condition under which the light emitter 49 of the medium detector 48 emits light Li on the recording medium P while the carriage driving part Pr3 moves the carriage 17 in a predetermined movement speed and the medium conveying part Pr2 conveys the recording medium P in a predetermined conveyance speed, so that the light emitter 49 of the medium detector 48 can emit the light Li on the recording medium P along the line L3. Thus, the medium identifying part Pr4 can analyze the sensor output along the line 3 on the recording medium P. Note that at least one of the movement speed of the carriage 17 and the conveyance speed of the recording medium P is changed relative to the other, the angle of the line L3 with respect to the main scanning direction can be changed.

Next, the medium identifying part Pr4 determines if the medium detection condition has been changed or not, and, when the medium detection condition has been changed, the medium detector 48 detects the recording medium P under the changed medium detection condition

When the detection process of the recording medium P by the medium detector 48 under the changed medium detection condition has been completed, the medium identifying part Pr4 performs again the frequency analysis on the sensor output under the changed detection condition, calculates the peak frequencies Fpk and the peak amplitudes Fpk of the sensor output, and determines whether the peak frequencies Fpk and the peak amplitudes Fpk of the sensor output are matched with the peak frequencies fpj and the peak amplitudes apj of any one of the known retroreflective media Px, which are stored in the ROM 81. When the peak frequencies Fpk and the peak amplitudes Fpk of the sensor output are matched with the peak frequencies fpj and the peak amplitudes apj of one of the known retroreflective media Px, the medium identifying part Pr4 determines that the recording medium P is a retroreflective medium Px. When the peak frequencies Fpk and the peak amplitudes Fpk of the sensor output are not matched with the peak frequencies fpj and the peak amplitudes apj of any one of the known retroreflective media Px, the medium detection condition changing part Pr5 determines whether the medium detection condition can be changed, and, when it is determined that the medium detection condition can be changed, changes the medium detection condition.

Accordingly, when the peak frequencies Fpk and the peak amplitudes Fpk of the sensor output are not matched with the peak frequencies fpj and the peak amplitudes apj of any one of the known retroreflective media Px, the medium detection condition is repeatedly changed until the peak frequencies Fpk and the peak amplitudes Fpk of the sensor output are matched with the peak frequencies fpj and the peak amplitudes apj of any one of the known retroreflective media Px or until the medium identifying processes under all of the predetermined detection conditions are completed. When the medium identifying processes under all of the predetermined detection conditions are completed, the medium identifying part Pr4 determines that the medium detection condition cannot be changed any more, and determines that the recording medium P is not a retroreflective media Px, that is, a normal recording medium.

When it is determined that the recording medium P is not a retroreflective medium Px but is a normal recording medium, the controller 80 executes a first print process.

In the first print process, the controller 80 reads out from the RAM 82 the print data, converts the print data to generate the image data. The controller 80 then transmits the image data to the recording heads Hdi, to execute printing.

For executing printing, the carriage driving part Pr3 moves the carriage 17 in the main scanning direction, and the medium conveying part Pr2 conveys the recording medium P, and the head driving part Pr1 drives the recording heads Hdi to eject the inks, so as to form (print) an image with the inks on the recording medium P

On the other hand, when it is determined that the recording medium P is a retroreflective medium Px, the image formation condition setting part Pr6 transmits to the outside dryer 61 an instruction to rise the temperature thereof. When receiving the temperature rising instruction, the dry controller 41 of the outside dryer 61 turns on the heater 39, and waits until the temperature of the heater 39 reaches a set temperature.

When the temperature of the heater 39 reaches the set temperature, the dry controller 41 transmits to the controller 80 a notification of the completion of rising the temperature, and the controller 80 then executes a second print process, when receiving the completion notification.

In the second print process, the controller 80 reads out from the RAM 82 the print data, converts the print data to generate the image data. The controller 80 then transmits the image data to the recording heads Hdi, to execute printing.

For executing printing, the carriage driving part Pr3 moves the carriage 17 in the main scanning direction, and the medium conveying part Pr2 conveys the recording medium P, and the head driving part Pr1 drives the recording heads Hdi to eject the inks, so as to form (print) an image with the inks on the recording medium P.

Then, the medium conveying part Pr2 further conveys the printed recording medium P, to further dry the inks attached on the recording medium P by the outside dryer 61. Note that during a period when the recording heads Hdi is driven to form the image on the recording medium P, the recording medium P is being conveyed, and thus the ink applied to the recording medium P is being dried by the outside dryer 61. The recording medium P is conveyed at least until a tail end of the ink image on the recording medium P passes through the outside dryer 61.

With this, even when the recording medium P is the retroreflective medium Px, the ink on the recording medium P can be sufficiently dried. Note that when the recording medium P is the normal recording medium or when the type of the recording medium cannot be identified even when the medium detection condition changing part Pr5 have changed to all of the predetermined medium detection condition, the recording medium P is not dried by the outside dryer 61, so that the recording medium P would not be excessively dried.

Note that the light passes through the film layer Sc. Thus, when a user or an operator conducts a visual check on the image formed on the retroreflective medium Px, a noticeability of the image on the retroreflective medium Px may be low if a density of the image is low. Accordingly, the density of the image formed on the retroreflective medium Px is set greater than that of the normal recording medium, and thus an amount of the inks ejected from the recording heads Hdi to the retroreflective medium Px is greater than that of the normal recording medium. Therefore, when the recording medium P is the retroreflective medium Px, the ink applied to the recording medium P may be required to be sufficiently dried by the outside dryer 61.

Further, when the recording medium P is the retroreflective medium Px, the printing mode may be changed to change the number of paths when recording one line. Thus, it may be preferable to change a drying condition for drying the ink applied to the recording medium P by means of the outside dryer 61.

Next, a flow chart illustrated in FIG. 9 is explained.

Step S1: The interface controller 83 receives the print data from the host computer.

Step S2: The medium detector 48 detects the recording medium P.

Step S3: The medium identifying part Pr4 executes the frequency analysis on the sensor output of the light receiver 50.

Step S4: The medium identifying part Pr4 determines whether the recording medium P is the retroreflective medium Px or not. When it is determined that the recording medium P is the retroreflective medium Px, the process proceeds to step S8. When it is determined that the recording medium P is not the retroreflective medium Px, the process proceeds to step S5.

Step S5: The medium detection condition changing part Pr5 executes the medium detection condition changing process.

Step S6: The medium detection condition changing part Pr5 determines whether the medium detection condition is able to be changed to one of predetermined medium detection conditions. When it is determined that the medium detection condition is able to be changed to one of the predetermined medium detection conditions, the process returns to step S2. When it is determined that the medium detection condition is not able to be changed to one of the predetermined medium detection conditions, for example, when it is determined that medium identifying processes under all of the predetermined medium detection conditions have already completed, the process proceeds to step S7.

Step S7: The controller 80 executes the first print process, and then ends the process.

Step S8: The image formation condition setting part Pr6 transmits an instruction to rise the temperature of the outside dryer 61.

Step S9: The dry controller 41 turns on the heater 39.

Step S10: The dry controller 41 waits until the temperature of the heater 39 reaches the set temperature. When the temperature of the heater 39 reaches the set temperature, the process proceeds to step S11.

Step S11: The controller 80 executes the second print process, and then ends the process.

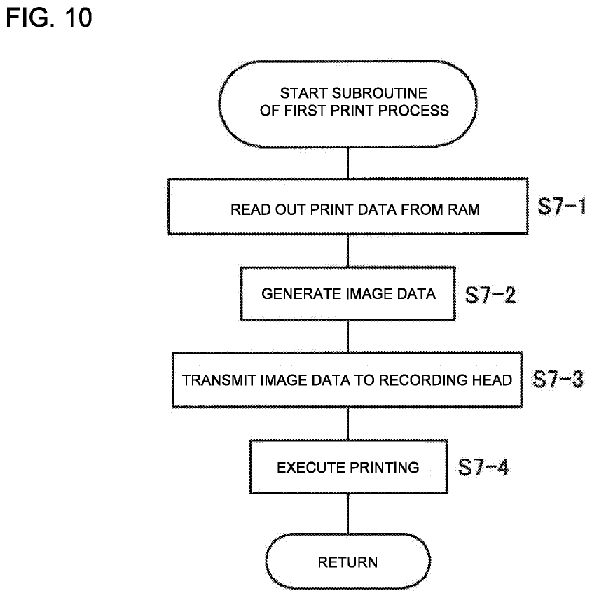

Next, a subroutine illustrated in FIG. 10 is explained.

Step S7-1: The controller 80 reads out from the RAM 82 the print data.

Step S7-2: The controller 80 generates the image data.

Step S7-3: The controller 80 transmits the image data to the recording heads Hdi.

Step S7-4: The controller 80 executes the printing and then returns the process.

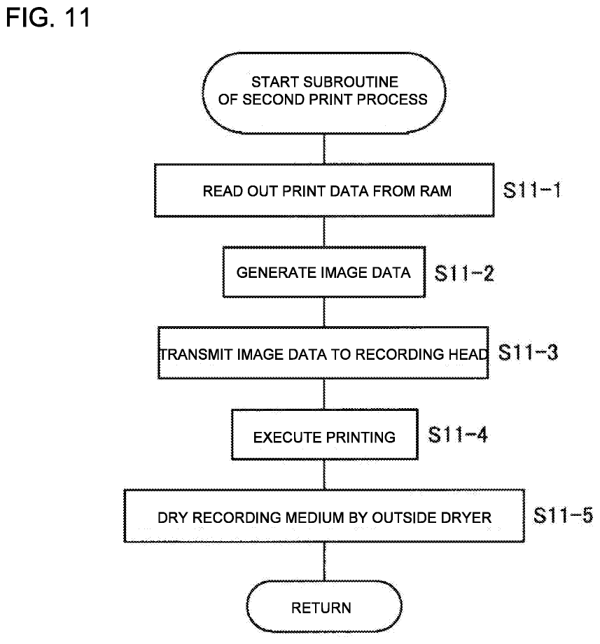

Next, a subroutine illustrated in FIG. 11 is explained.

Step S11-1: The controller 80 reads out from the RAM 82 the print data.

Step S11-2: The controller 80 generates the image data.

Step S11-3: The controller 80 transmits the image data to the recording heads Hdi.

Step S11-4: The controller 80 executes the printing.

Step S11-5: The medium conveying part Pr2 convey the recording medium to cause the outside dryer 61 to dry the recording medium, and then returns the process.

According to one or more embodiments described above, the printer 10 obtains the sensor output of the medium detector 48 including plural detecting point on the recording medium P, calculates, based on the obtained sensor output, the peak frequencies Fpk and peak amplitudes Fpk which indicate characteristic of the recording medium P, identifies, based on the peak frequencies Fpk and peak amplitudes Fpk, the type of the recording medium P. Accordingly, even if the recording medium P is a retroreflective medium Px, the printer 10 can appropriately identify the type of the recording medium P based on the sensor output of the medium detector 48, and thus is able to execute printing under an appropriate print setting suitable for the characteristics of the recording medium P.

Further, according to one or more embodiments, the printer 10 is able to execute printing under an appropriate print setting suitable for the characteristics of the recording medium P, even though structures of retroreflective media Px are different from each other depending on types of the retroreflective media Px and manufacturers of the retroreflective media Px.

In an embodiment, when the medium detection condition changing part Pr5 changes the medium detection condition, the medium detector 48 can detect the recording medium P under the changed medium condition, for example, (i) by conveying the recording medium P in the conveyance direction by a predetermined distance to change a position of the recording medium P on the platen 25 and then emitting the light Li to the recording medium P by the light emitter 49 of the medium detector 48 along the line L2, or (ii) emitting the light Li to the recording medium by the light emitter 49 of the medium detector 48 along the line L3 while conveying the recording medium P. However, in a modification, a plurality of optical sensor 24 may be provided such that light emitters 49 of medium detectors 48 of the plurality of optical sensors 24 concurrently emit lights Li to the recording medium P along lines L1, L2, and L3, to thereby obtain a plurality of sensor outputs at the same time.

In an embodiment, the medium detection condition changing part Pr5 can change the medium detection condition by only slightly changing the position where the carriage 17 scans (moves) above the recording medium P to thereby change the scanning position of the medium detector 48 on the recording medium P.

In such a case, the medium detection condition changing part Pr5 issues an instruction to the medium conveying part Pr2 to convey the recording medium P by a predetermined distance, for example, approximately 50 mm or the like. Such a medium detection condition changing process may prevent an error in identifying the type of the recording medium P, even though a dirt is attached to the recording medium P or a dent, a scratch, or the like exists on the recording medium P.

Depending on the pattern of the support layer Se of the retroreflective medium Px, the printer 10 sometimes cannot appropriately analyze the frequency of the sensor output. However, because the medium detection condition changing part Pr5 issues the instruction to the medium conveying part Pr2 to convey the recording medium P by the predetermined distance, for example, approximately several mm as described above, the printer 10 can appropriately complete the frequency analysis of the sensor output. One cycle of the pattern of the retroreflective medium Px usually is within approximately 3-mm to 10-mm squire, and therefore the printer 10 may convey the recording medium P by approximately several mm to change the medium detection condition.

In the above described one or more embodiments, upon detecting the recording medium P, the printer 10 moves the carriage 17 while moving the recording medium P on the platen 25 or moves the carriage 17 while stopping the recording medium P on the platen 25. However, in a modification, upon detecting the recording medium by means of the optical sensor 24, the printer 10 may convey the recording medium P on the platen 25 while stopping the carriage 17.

In the above described one or more embodiments, when the peak frequencies Fpk and the peak amplitudes Fpk of the sensor output are not matched with the peak frequencies fpj and the peak amplitudes apj of any one of the registered sample recording media, the medium detection condition is repeatedly changed until the peak frequencies Fpk and the peak amplitudes Fpk of the sensor output are matched with those of any one of the registered sample recording media or until the medium identifying processes under all of the predetermined medium detection conditions are completed. The contents of the predetermined medium detection conditions and an order of changing the predetermined medium detection conditions may be preset.

Such a preset changing order may be set such that a load applied to the carriage motor 22 to move the carriage 17 or a load applied to the conveyance motor 34 to move the recording medium P upon transitioning from the current medium detection condition to the next medium detection condition is small and a time transitioning from the current medium detection condition to the next medium detection condition is short.

In the above describe one or more embodiments, the reflective layer Sd of the retroreflective medium Px includes the prismatic layer containing the prisms as the refractive layer. In a modification, the reflective layer Sd of the retroreflective medium Px may include a bead layer containing beads.

In one or more embodiments described above, the inkjet printer 10 is described, however, the invention is not limited to this. For example, an embodiment or a modification may be applied to an image formation apparatus such as a copier, a facsimile, a multi-function printer or peripheral (“MFP”), or the like, and may be applied to an image reading apparatus such as a scanner or the like.

The invention includes other embodiments or modifications in addition to the above-described one or more embodiments without departing from the spirit of the invention. The above-described one or more embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An image formation apparatus comprising:
a sensor unit provided at a movable part being movable in a main scanning direction;
a driver configured to move a medium in a sub-scanning direction;
a controller that controls the sensor unit, the movable part, and the driver, wherein the controller controls the sensor unit to detect the medium while controlling the movable part to move in the main scanning direction without driving the driver, and controls the sensor unit to detect the medium while controlling the movable part to move in the main scanning direction with controlling the driver to move the medium in the sub-scanning direction.

2. The image formation apparatus according to claim 1, wherein
the controller comprises a medium processor that identifies a type of the medium based on a detection result of the sensor unit.

3. The image formation apparatus according to claim 2, wherein
the medium processor comprises a medium identifying part that execute a first identification process that controls the sensor unit to detect the medium while controlling the movable part to move in the main scanning direction without driving the driver, and a second identification process that controls the sensor unit to detect the medium while controlling the movable part to move in the main scanning direction with controlling the driver to move the medium in the sub-scanning direction.

4. The image formation apparatus according to claim 3, wherein
the medium processor comprises a medium detection condition changing part that changes, when the medium identifying part cannot identify the type of the medium in the first identification process, a setting of the first identification process.

5. The image formation apparatus according to claim 3, wherein
the medium identifying part executes the second identification process to identify the type of the medium, when the medium identifying part cannot identify the type of the medium in the first identification process.

6. The image formation apparatus according to claim 2, wherein the medium processor compares the detection result of the sensor unit with stored information of sample media, to identify the type of the medium.

7. The image formation apparatus according to claim 1, wherein
the sensor unit comprises a light emitter to emit light to the medium and a light receiver to receive light reflected from the medium.

8. The image formation apparatus according to claim 7, wherein
the controller generates, based on a detection result of the light receiver, one or more peak waveforms which indicate characteristics of the detection result.

9. The image formation apparatus according to claim 8, wherein
the controller calculates, based on the one or more peak waveforms, a peak frequency and a peak amplitude of each of the one or more peak waveforms.

10. The image formation apparatus according to claim 9, wherein
the controller identifies a type of the medium based on the peak frequency and the peak amplitude.

11. The image formation apparatus according to claim 1, further comprising
an image formation part configured to form an image on the medium.

12. The image formation apparatus according to claim 11, wherein
the image formation part comprises an inkjet head.

13. The image formation apparatus according to claim 1, wherein
the controller identifies, based on a detection result of the sensor unit, whether the medium is a retroreflective medium or not.
